(19) United States
(12) Patent Application Publication
(10) Pub. No.: US 2008/0285485 A1
(43) Pub. Date: Nov. 20, 2008

(54) SYSTEM AND METHOD FOR RECORDING VOIP IN A NETWORK ADDRESS/PORT TRANSLATION ENVIRONMENT

(75) Inventor: CHRISTOPHER G. KINGSLEY, PEEL, AR (US)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(73) Assignee: EDIGIN, INC., Enid, OK (US)

(21) Appl. No.: 12/122,025

(22) Filed: May 16, 2008

Related U.S. Application Data
(60) Provisional application No. 60/938,548, filed on May 17, 2007.

(51) Int. Cl. H04L 12/16

(52) U.S. Cl. 370/259

(57) ABSTRACT

A method of recording voice over internet protocol (VOIP) data is disclosed. The method includes receiving a control packet, examining an application layer of the control packet to dynamically determine an internet protocol address and a port number of a VOIP device, and storing the internet protocol address and port number for recording of data packets having the same internet protocol address and port number.

### CROSS REFERENCE TO RELATED APPLICATIONS

This application claims the priority of U.S. Provisional Patent Application No. 60/938,548 entitled “SYSTEM & METHOD FOR RECORDING VOIP IN A NETWORK ADDRESS/PORT TRANSLATION ENVIRONMENT,” filed May 17, 2007, the contents of which are hereby incorporated by reference.

### FIELD OF THE INVENTION

The present disclosure is related generally to the field of telecommunications and, more specifically, to voice over Internet protocol (VOIP) technologies.

### BACKGROUND OF THE INVENTION

In order to reduce costs, among other reasons, telecommunications customers, both enterprises and individuals, are employing VOIP solutions. However, customers may not be satisfied to simply have a voice carrying capability since customers have long been accustomed to enhanced features even with traditional copper wire systems. These enhanced features include, among others, the ability to selectively record phone conversations.

With a traditional phone line this can be fairly simple prospect. For example, a user may acquire an answering machine and place it in-line with the phone. Traditional phones are also available with answering machines and other functionality built in. Such devices often have the capability of recording both parties to a conversation in addition to storing incoming messages. While these solutions are often adequate for individual customers, enterprise level customers have typically employed more complex equipment to attain the desired functionality. However, as both individuals and enterprise customers move to VOIP, new solutions that work with VOIP technology are needed.

### SUMMARY OF THE INVENTION

The present invention disclosed and claim herein, in one aspect thereof, comprises a method of recording voice over internet protocol (VOIP) data. The method includes receiving a control packet, examining an application layer of the control packet to dynamically determine an internet protocol address and a port number of a VOIP device, and storing the internet protocol address and port number for recording of data packets having the same internet protocol address and port number. The method may also include dynamically creating a network level filter and a transport layer filter to determine whether data packets contain the internet protocol address and port number of the VOIP device. The control packet may be a packet corresponding to an initiation of a VOIP call, and may be inbound to a VOIP call agent or outbound from a VOIP call agent.

The method may also include receiving a data packet, examining the data packet to dynamically determine an internet protocol address and a port number of the data packet, and selectively recording the data from the data packet based on whether the internet protocol address and port number of the data packet matches that of the VOIP device.

The data packet may be received at an application layer of a network. The data packet may be received on a public side of a router performing network address translation on the originating control packet. In one embodiment, receiving a data packet further comprises receiving a VOIP packet at an application layer gateway recorder (ALGR) from a network switch delivering VOIP packets to a session border controller (SBC) and the ALGR.

The present invention disclosed and claimed herein, in another aspect thereof, comprises a device for recording VOIP data. The device may include a network interface, a non-volatile means for storing instructions, and a processor that executes the instructions. The instructions may include instructions for inspecting a control packet corresponding to a VOIP call to determine an internet protocol (IP) address and a port number associated with a VOIP device corresponding to the VOIP call, and selectively recording voice data contained in data packets based on whether an IP address and port number from the data packets matches the IP address and port number associated with the VOIP device. The instructions may also include instructions for storing a cache of IP addresses and port number associated with VOIP devices.

In some embodiments, the network interface implements at least part of the Open Systems Interconnect (OSI) network model and the IP address and port number are determined from an application layer of the implemented OSI model. The network interface may be connected to a public network and receive network address translated (NATed) data packets.

### BRIEF DESCRIPTION OF THE DRAWINGS

FIG. 1. is a schematic diagram of a private voice over internet protocol (VOIP) network.

FIG. 2 is a schematic diagram of a public VOIP network.

FIG. 3 is a schematic diagram of a number of application layer gateway recorders (ALGRs) in a hosted VOIP data center.

FIG. 4 is a session communication diagram of an examination of control packets for recording VOIP data.

FIG. 5 is a flow diagram of one method of operation of an ALGR.

### DETAILED DESCRIPTION OF THE PREFERRED EMBODIMENTS

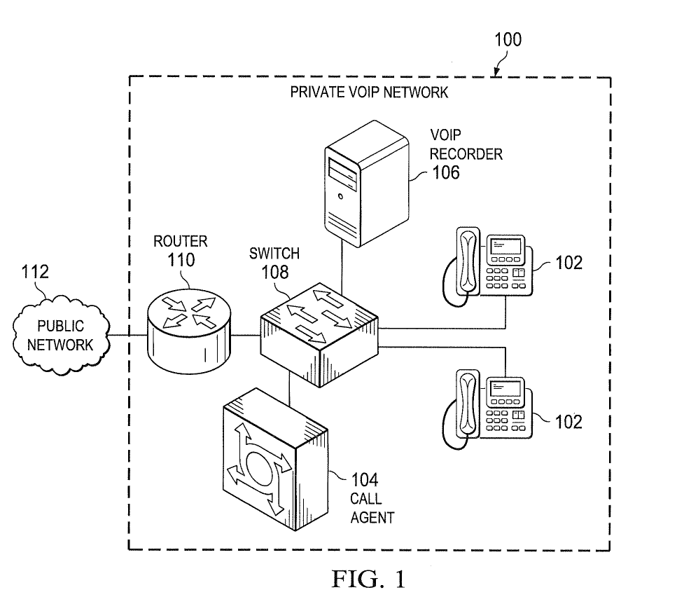

Referring now to FIG. 1, a schematic diagram of a private voice over internet protocol (VOIP) network 100 is shown. In such a network, VOIP communications may include two types of communication packets: control packets for registration and setup of calls, and data packets that carry the actual audio and/or video payload. Control packets flow between one or more VOIP devices 102 and a call agent 104. The control packets may be handled according to various call control protocols such as SIP, Cisco Skinny, H.323, MGCP, and others. The VOIP devices may be dedicated VOIP telephones or may be implemented using a personal computer. In some embodiments, the VOIP devices 102 may be part of a portable device such as a laptop computer. The VOIP devices 102 could also be multipurpose communication devices such as mobile phones that are also capable of communicating via a mobile phone network or a mobile broadband network. The audio/video session may be conducted using the Realtime Transport Protocol (RTP) or another suitable protocol. The data packets will flow between the two devices that are communicating (e.g, the VOIP devices 102).

One method of recording VOIP telephone calls is to connect a recorder 106 via an ethernet connection to a private network switch 108. The switch 108 is behind a router 110, to which the VOIP devices 102 are connected. The switch 108 is managed to mirror the ethernet (packet) traffic to/from those VOIP devices 102 to the ethernet interface on the switch 108 that connects to the recorder 106. The recorder 106 may use packet sniffing technology to filter the network traffic looking for specific local internet protocol (IP) addresses and medium access control (MAC) addresses that correspond to the devices 102 that need to be recorded. MAC address filtering may be used in environments where the VOIP uses dynamic host configuration protocol (DHCP) to obtain IP address. In an environment where the devices use static IP addresses, an IP address filter may be used. The recorder 106 may also examine control messages to determine information about the communication, such as the calling party or called party.

The VOIP network of FIG. 1 is an internal VOIP network suitable for use on a local area network (LAN). This may be useful for a corporate or enterprise environment where multiple internal phone lines may be needed. It may also be the case that the LAN connects to a public network 112 which may be wide area network (WAN) or the internet. However, additional steps may be needed before calls between VOIP devices on separate private networks can be conducted or recorded.

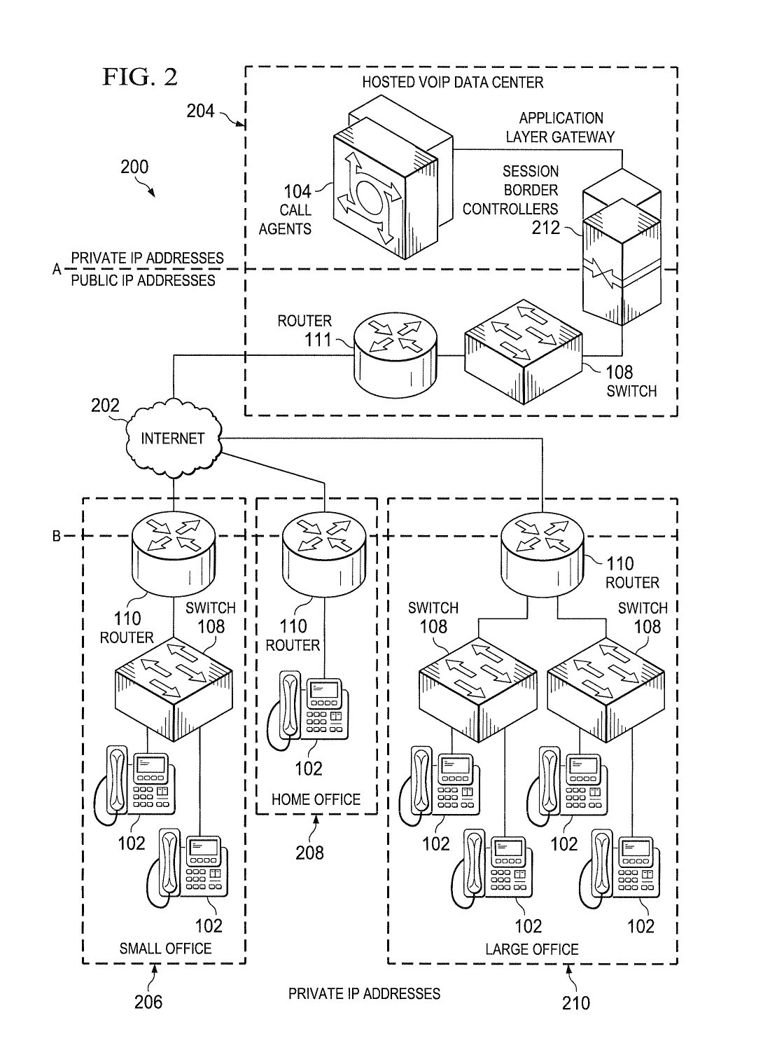

Referring now to FIG. 2, a schematic diagram of a public VOIP network 200 is shown. This configuration may also be referred to as a hosted environment. Here, a service provider makes VOIP equipment publicly available to their customers over the internet 202. In one embodiment, the VOIP equipment is physically stored at a hosted VOIP data center 204. Communications from the data center 204 occur over the internet to various customer locations. These may include a small office 206, a home office 208, and/or a large office 210. Although for simplicity, only one of each of these types of customers is shown, it is understood that many more may be able to simultaneously connect to the data center 204.

The hosted VOIP data center 204 may comprise various components such as a switch 108 and a router 111. The router 111 serves to interface with the customers through the internet 202, directing internet traffic (e.g., VOIP phone calls) to the switch 108, which routes the packets to the appropriate locations in the data center 204. In the present embodiment, the switch 108 forwards packets to the session border controllers 212. Call agents that handle the voice content of the VOIP calls interface with the session border controllers 112. In the present embodiment, the call agents 214 will interface with a public switched telephone network (PSTN) connecting to a traditional phone line to complete the voice call (if necessary).

As mentioned, a number of customers may interconnect to complete VOIP calls with the data center 204. The customers may range in size and complexity. A home office 208, for example, may have a single VOIP device 102 behind a router 110 interfacing with the data center 204 via the internet 202. Other customers may have more complex operations. A small office 206 may have multiple VOIP devices 102 with local packet traffic connecting to a router 110 by a switch 108. A large office 210 may have multiple VOIP devices 102 connecting through multiple switches 108 to a router 102 that interfaces with the data center 204 via the internet 202.

It will be appreciated that systems that interface via the internet or other large networks may utilize network address translation (NAT). This results in IP addresses being either private or public. In one embodiment, the routers 110 perform the address translation for the customers. This allows those customers operating with a router to have a number of private IP addresses for use within their own private networks. Ordinarily, these IP addresses are not seen by devices on the other side of the local router 110. A router 110 will provide its own public IP address for all network traffic leaving the local customer networks. Thus, for each of the example customers (the small office 206, the home office 208, and the large office 210) any device on the internet 202 will only see the IP address of the local router 110 and not that of the individual VOIP device 102. This means that more than one VOIP device 102 will have the same public IP address provided by the local router 110. In FIG. 2, the areas where public IP addresses are used are denoted by the lines A and B. Between these lines, public IP addresses are used, outside these lines private addresses are used.

In the present embodiment, all VOIP devices 110 register with the session border controller (SBC) 212 with a public IP address in order to communicate via VOIP. All control and data packets relating to the VOIP call will travel to the SBC 212. Thus the SBC acts as a proxy for the call agents 214 performs the application layer gateway (ALG) function that allows VOIP phones 102 to communicate from behind a NATed router (e.g., customer routers 110).

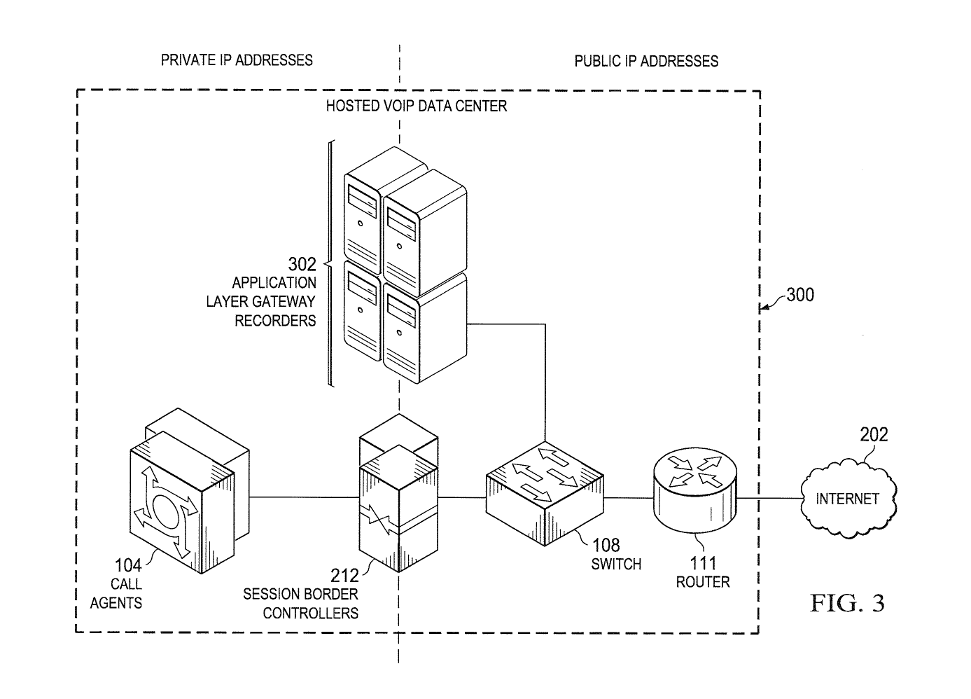

Referring now to FIG. 3, a schematic diagram of a number of application layer gateway recorders (ALGRs) 302 in a hosted VOIP data center 300 are shown. The ALGRs 302 may be implemented in hardware, software, or a combination thereof. The ALGRs 302 understand the network address and port translations performed by the ALG functionality of the SBC 212. Therefore, the ALGRs 212 are able to properly filter, recognize, and record VOIP traffic in a public environment. The ALGRs 302 are connected to the same switch 108 as the SBCs 212, and all traffic going in/out of the public side of the SBCs 212 is mirrored to the ALGRs 302. The ALGRs 320 are therefore able to observe and act on communications to and from the SBCs 212.

Networks may be conceptualized by referenced to the Open Systems Interconnect (OSI) model. In the OSI model, layer 7 is an application layer and layer 6 is a presentation layer. Network packets may comprise the following OSI layers:

Layer 5—Application Layer (SIP, Skinny, H.323, MGCP, etc.)

Layer 4—Transport Layer (TCP or UDP) (port numbers)

Layer 3—Network Layer (IP) (IP addresses)

Layer 2—Data Link Layer (Ethernet) (MAC addresses)

Layer 1—Physical Layer, wiring

An ALG (e.g., an ALGR 302 or an SBC 212) is a layer 5 packet proxy for VOIP communication. This allows VOIP devices behind NATed routers to communicate. ALGs are protocol specific. An ALG may support one or more protocols including, but not limited to, H.323, SIP, Skinny, MGCP, or others. During call setup a VOIP endpoint (e.g., devices 102) will send/receive layer 5 messages to a call agent 104 via the SBC 212. Those layer 5 messages contain private IP addresses and port numbers which the devices 102 may use to communicate. Layers 2-4 of those messages are changed by the router (e.g., customer routers 110) via the NAT operation. The ALG understands the NAT and will manipulate the layer 5 Control messages of the call agents 104 by changing the private IP addresses and port numbers in the layer 5 messages to public IP addresses and port numbers of the SBC 212. This forces all communication between the VOIP devices 102 and call agents 104 to go through the SBC 212, which acts as a proxy for communication between the devices.

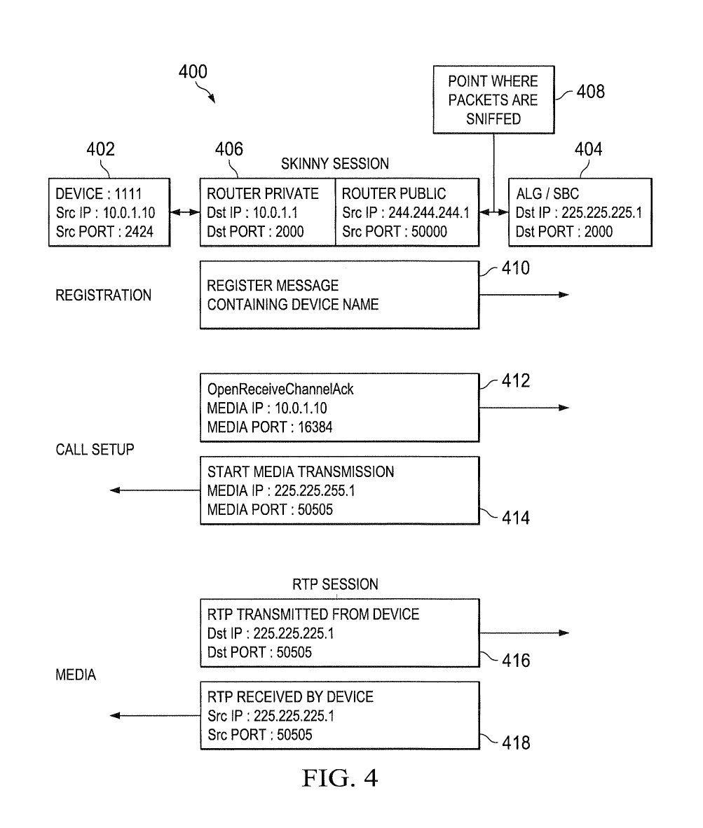

Referring now to FIG. 4, a session communication diagram of an examination of control packets by an ALGR 302 for recording VOIP data is shown. This diagram is exemplary only and illustrates a method for processing a Cisco Skinny packet according to the present disclosure. An ALG is protocol specific and must be able to understand and manipulate layer 5 packets that contain layer 3 IP addresses and layer 4 port numbers. As described, changing the IP addresses and port numbers in the media setup messages forces the endpoints to communicate via the SBC 212 instead of directly.

The ALGR 302 also examines layer 5 control packets to perform its recording function. This is shown in FIG. 4, however, for simplicity, not all packets are shown. A Skinny session 406 is setup between the VOIP device 402 and the ALG/SBC 404. The ALGR will sniff packets for the appropriate information along path 408. A registration message 410 is transmitted. The message 410 contains the VOIP device name and is intercepted by the ALGR. In the example shown, the ALGR dynamically binds IP/Port 244.244.244.2:50000 to that device. Setup messages, such as message 412 may be passed back and forth and also sniffed by the ALGR. Setup messages from the bound IP/Port are examined to determine a dynamic RTP session IP/port for each session. RTP packets 416 from 225.225.225.1:50505 provide the media going to the device 402 and RTP packets 418 to 225.225.225.1:50505 provide the media coming from the device 402. The ALGR processes media from both sides of the conversation and associates it with the correct device (e.g., a VOIP device 102).

In order to implement the procedure described above (whether with Cisco Skinny or another protocol), the ALGR may use all 5 layers of the OSI model. By examining layer 5 messages, the ALGR determines in real-time which VOIP sessions are associated with the devices that need to be recorded and dynamically creates layer 3 and layer 4 filters to process the correct packets.

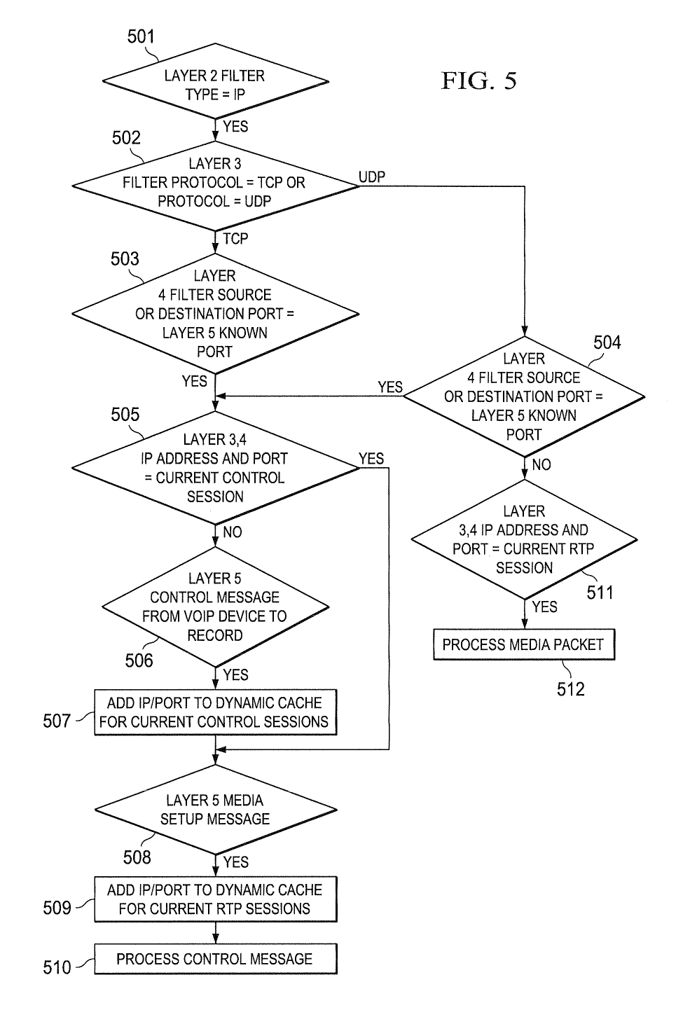

Referring now to FIG. 5, a flow diagram 500 of one method of operation of an ALGR is shown. The diagram 500 represents an exemplary embodiment of a method by which an ALGR can filter and inspect OSI layer 5 messages in order to correctly identify and record VOIP conversations and/or data. The ALGR will be able to properly identify and record conversations from a VOIP device, even if that device is behind a router performing network address translations (e.g., the VOIP devices 102 behind routers 110 in FIG. 1).

At step 510, the layer 2 Ethernet frame is examined to verify the type of layer 3 packet it contains is of type IP, that is internet protocol. All other types are discarded at this step. The packets are only discarded as regarding the ALGR. This means the ALGR will ignore these as they pass from the switch. At step 502, the layer 3 IP frame is examined to verify the layer 4 protocols it is carrying is of type transmission control protocol (TCP) or user datagram protocol (UDP). All other protocols are discarded/ignored by the ALGR.

If the layer 3 IP frame contains TCP, the layer 4 TCP frame is examined at step 503 to determine if the source or destination port are a known port number for a layer 5 control message. This determination may be based upon the layer 5 protocols used and their associated ports. Some layer 5 protocols that use TCP include Skinny and H.323.

If the layer 3 IP frame contains UDP, the layer 4 UDP frame is examined at step 504 to determine if the source or destination port are a known port number for a layer 5 control message. Again, this determination may be based upon the layer 5 protocols and their associated ports. Some layer 5 protocols use that use UDP include session initiation protocol (SIP) and media gateway control protocol (MGCP).

At step 505, a determination is made as to whether the control packet has a layer 3 IP address and a layer 4 port number corresponding to a VOIP device that requires recording. The ALGR maintains a dynamic cache of IP addresses and port numbers corresponding to devices and sessions requiring recording.

If, at step 505, the control packet does not match anything in the layer 3/layer 4 dynamic cache, a determination is made at step 506 as to whether the control message contains identifying registration or setup information for a VOIP device that needs to be recorded. If device identifying information is found, the IP address and port number pair for the device are added to the control session cache at step 507.

At step 508, the layer 5 setup messages that contain the public IP address and port number that the RTP payloads will be transmitted on are identified. As described, the ALGR maintains a dynamic cache of IP address and port number pairs to VOIP device media transmission for each new communications session. At step 509, during session setup, the public IP address and port number pair for the device is added to the RTP Session cache. At step 510 session messages for known devices are filtered for the purpose of starting and stopping a recording, determining information about the session such as calling and called party or direction, or looking for specific events such as key presses.

At step 511, if the UDP packet contains RTP data and the IP Address and the port number matches a device in the Current RTP Session cache, the packet is sent to media processing. At step 512, the message will be processed. The voice data contained in the VOIP packet will be stored based on one of various media recording protocols such as MP3. In addition to actual conversation, event notifications may also be contained in the voice data and may be recorded as well. Event notifications may include but are not limited to signals for offhook, onhook, hold, mute, conference, transfer, park, pickup, and button presses. The media recorder may be implemented in hardware or software or a combination thereof. In some embodiments, the media recorder may be located on the same physical machine as the ALGR 302 (FIG. 3)

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

What is claimed is:

1. A method of recording voice over internet protocol (VOIP) data comprising:
receiving a control packet;
examining an application layer of the control packet to dynamically determine an internet protocol address and a port number of a VOIP device; and
storing the internet protocol address and port number for recording of data packets having the same internet protocol address and port number.

2. The method of claim 1, further comprising dynamically creating a network level filter and a transport layer filter to determine whether data packets contain the internet protocol address and port number of the VOIP device.

3. The method of claim 1, wherein the control packet is a packet corresponding to an initiation of a VOIP call.

4. The method of claim 1, wherein receiving a control packet further comprises receiving a control packet that is inbound to a VOIP call agent.

5. The method of claim 1, wherein receiving a control packet further comprises receiving a control packet that is outbound from a VOIP call agent.

6. The method of claim 1, further comprising:
receiving a data packet;
examining the data packet to dynamically determine an internet protocol address and a port number of the data packet; and
selectively recording the data from the data packet based on whether the internet protocol address and port number of the data packet matches that of the VOIP device.

7. The method of claim 6, wherein the data packet is received at an application layer of a network.

8. The method of claim 6, further comprising receiving the data packet on a public side of a router performing network address translation on the originating control packet and data packet.

9. The method of claim 6, wherein receiving a data packet further comprises receiving a VOIP packet at an application layer gateway recorder (ALGR) from a network switch delivering VOIP packets to a session border controller (SBC) and the ALGR.

10. A method of recording voice over internet protocol (VOIP) conversations comprising:
at an application layer gateway recorder (ALGR), inspecting a packet corresponding to a registration of a VOIP device to determine an internet protocol (IP) address and a port number associated with the VOIP device; and
recording voice data contained in subsequent data packets based on the IP address and port number.

11. The method of claim 10, further comprising associating the IP number and port address with a specific call from the VOIP device in a dynamic cache.

12. The method of claim 10, wherein inspecting a packet corresponding to a registration of a VOIP device further comprises inspecting a packet corresponding to registration of a VOIP device with a session border controller (SBC).

13. The method of claim 10, wherein recording voice data contained in the packet based on the IP address and port number further comprises recording the voice data contained in the packet when the IP address and port number match the IP address and port number of the VOIP device.

14. The method of claim 10, further comprising:
at the ALGR, inspecting a packet corresponding to a registration of a second VOIP device to determine an address and a port number associated with the second VOIP device; and
wherein recording voice data contained in subsequent data packets based on the IP address and port number further comprises recording the voice data in association with the first or second VOIP device dependant upon which VOIP device matches the IP address and port number of the packet.

15. The method of claim 10 wherein the voice data includes event notifications.

16. The method of claim 10, wherein the IP address is determined from an Open Systems Interconnect (OSI) layer 5 application layer.

17. The method of claim 10, wherein the port number is determined from an Open Systems Interconnect (OSI) layer 5 application layer.

18. A device for recording voice over internet protocol (VOIP) data comprising:
a network interface;
a non-volatile means for storing instructions; and
a processor that executes the instructions;
wherein the instructions comprise instructions for:
inspecting a control packet corresponding to a VOIP call to determine an internet protocol (IP) address and a port number associated with a VOIP device corresponding to the VOIP call; and
selectively recording voice data contained in data packets based on whether an IP address and port number from the data packets matches the IP address and port number associated with the VOIP device.

19. The device of claim 18, wherein the network interface implements at least part of the Open Systems Interconnect (OSI) network model and wherein the IP address and port number are determined from an application layer of the implemented OSI model.

20. The device of claim 18, wherein the network interface is connected to a public network and receives network address translated (NATed) data packets.

21. The device of claim 18, wherein the instructions further comprise instructions for storing a cache of IP addresses and port number associated with VOIP devices.
